(19) United States
(12) Patent Application Publication
(10) Pub. No.: US 2019/0112044 A1
(43) Pub. Date: Apr. 18, 2019

(54) Drone Holster

(71) Applicant: Jeffrey Overall, Fountain Valley, CA (US)

(72) Inventor: Jeffrey Overall, Fountain Valley, CA (US)

(21) Appl. No.: 15/786,774

(22) Filed: Oct. 18, 2017

(51) Int. Cl. B64C 39/02; B64C 27/08

(52) U.S. Cl. CPC B64C 39/024; B64C 27/08; B64C 2201/203; B64C 2201/201; B64C 2201/024

(57) ABSTRACT

Devices and methods for transporting and storing a drone. Polycarbonate or material of similar resiliency is used to create a casing for the drone body. Stationary wing or retractable wing drones can be protectively coupled and attached to objects for transportation. The casing is comprised of a hood to cover the top of the drone and a carriage to receive the sides and bottom of the drone. The device allows quick access and greater versatility in storage and transportation of drones.

### FIELD OF INVENTION

The present invention relates to the protection of drones. Specifically, it relates to devices and methods of coupling and protecting a drone during transportation and storage.

### LIST OF PRIOR ART

U.S. Patents

| Pat. No.: | Kind Code: | Grant Date: | Patentee: |
|---|---|---|---|
| 3,675,834 | A | 1972 Jul. 11 | Peters |
| 6,363,244 | B1 | 2002 Mar. 26 | McGhee |
| 6,742,685 | B2 | 2004 Jun. 1 | Williams |
| 7,106,858 | B2 | 2006 Sep. 12 | Goldberg |
| 7,180,735 | B2 | 2007 Feb. 20 | Thomas |
| 7,889,494 | B2 | 2011 Feb. 15 | Stampfli |

### BACKGROUND

Drones and other unmanned vehicles are now produced in a variety of shapes and sizes. Advances in technology have enabled decreases in the size of drones with high tech capabilities. Sensors, cameras, retractable wings and other electrical components are integrated into drones. The “quadcopter,” a popular drone design, includes four equally spaced, stationary wings. The wings and propellers do not retract and are exposed to damage during transportation and storage. The body and wings of retractable wing drones are also susceptible to damage.

Transportation devices designed specifically for drones exist. Backpacks and carrying cases allow a user to enclose the drone during, transportation and protect against damage. These methods have drawbacks. Carrying cases are cumbersome and can be dropped, resulting in damage or loss. Backpacks can be overly bulky and difficult to access. Opening zippers, latches, or other binding mechanisms is time consuming, prohibiting quick access. The space provided by backpacks and cases often exceeds what is needed to effectively store a drone. Drones can be damaged due to movement when cases and backpacks are not specifically configured for secure storage.

Drones are increasingly used in photography and videography. As a recording tool, quick access is necessary to catch transitory scenes. Photographers and videographers often search on foot for the right setting before launching a drone. The drone must be accessed and quickly launched. Traditional storage methods can delay this process.

Damage can also occur when drones are manually handled or stored. Falling or other contact can damage the wings, camera or other components. The drone can be placed in a case or other protective enclosure, but again, this takes up excess space and requires the additional step of removal when accessing the drone.

The present invention allows easy access while protecting the drone during transportation and storage. The propellers and top of the drone are covered and the body of the drone is securely coupled. Snap-hooking or other quick release method is used to removably couple the drone. This method allows quick installation and removal. Drones can be easily accessed and ready for operation quicker than by current storage methods.

The drone can be attached to a pack, garment, or other object during transportation. Storage takes less space because the device is configured to contour to the drone. Versatility allows the attachment to the object most appropriate for the drone size and shape. Drones can be transported hands-free when there is no room for storage in a case or backpack. Space is freed up for storage of other items. The device can be used to provide additional protection when the drone is stored in a case or pack, or as the sole means of storage.

The drone remains partially exposed. In some embodiments exposure can permit calibration of drone and camera settings, and manipulation of the drone while it is still coupled.

The ability to couple the device allows use of both hands to manipulate the drone. The drone does not have to be placed on the ground or other surface. The holster protects the wings and body of the drone while other areas or components of the drone, such as a camera, are manipulated.

### SUMMARY

Disclosed are devices and methods of protectively storing and transporting drones. An exemplary embodiment is discussed. A hood is attached to a drone carriage. The hood is made of a resilient material permitting protection of the top of the drone body and stationary drone wings. Resilient material is polycarbonate, glass-filled nylon or other glass-filled polymer, plastic, or other rigid material with similar ductility. The hood has four arms configured to cover and protect the propellers of a stationary wing quadcopter drone. The propellers and rotors are often the most fragile aspects of the drone, making their protection paramount.

Rings on two of the hood arms permit attachment of a carabiner or other supplementary coupling device. Multiple rings allow attachment of the exemplary device in the most advantageous position,

A drone carriage is conjoined with the drone hood in two places. The two sides of the drone carriage extend down from the hood. The drone carriage is comprised of a stationary top scaffold and a bottom drone harness. The base of the drone harness joins both sides of the carriage and is configured to receive the bottom of the drone body. One side of the carriage has a hinge attaching the harness to the scaffold. The hinge enables the harness to pivot relative to the scaffold. The opposing side of the carriage is coupled by a snap-hook. The male aspect of the snap-hook is on the scaffold and the female aspect is aligned in the harness. When the snap-hook is locked the carriage is arranged to conform to, and securely couple the drone. The carriage forms a contiguous, U-shaped surface when locked.

Polyurethane padding may line the bottom of the drone hood and surfaces of the carriage that abut the drone. The padding prevents scratching and decreases the likelihood of other damage to the drone. The padding is thin to allow embedding into the wing and provides force absorption.

### Operation

The drone body is placed in the open drone carriage. The hinge allows a harness aspect of the carriage to pivot. The harness contains a snap-hook aspect. The harness side of the harness opposing the hinge may be attached with the scaffold by the snap-hook for quick-release coupling of the drone. When the snap-hook is locked the drone is securely coupled. A carabiner or other supplementary coupling device is attached to one of the rings. The supplementary coupling device is used to attach the invention to the means of transportation. When the drone is needed for operation the snap-hook is undone and the drone is removed from the carriage.

The holster protects the drone. When the drone is placed in a backpack, transported by hand, or stored, the drone can be placed in the holster for additional protection. The hood extends beyond the extremities of the wings and body, absorbing the force of any object or surface before it contacts the drone. The drone remains partially exposed, allowing easy access to the camera and other components.

The holster can be configured for all sizes of drones. Alternative embodiments of the carriage may have a different form, dependent on the dimensions of the drone body.

Many drones have retractable wings. Alternative embodiments may include hoods configured to cover the wings in their retracted position. Some drone designs have a different number of wings or alternative wing configurations. Alternative embodiments may have hoods configured to cover a different number of wings or different wing configurations.

The carriage configuration needs to provide the balance and support necessary for secure coupling of the drone. Alternative embodiments may include additional support platforms extending from the carriage to provide optimal balance and coupling of the drone body.

Alternative embodiments may include a permanently attached supplemental coupling device. The device may include a retractable reel, extension cord, lanyard, toggle, or other extendable implement to allow greater range of handheld manipulation of the drone while the device is attached. For smaller drones, the supplemental coupling device may be configured to attach to a keychain, or have a keychain permanently attached.

Alternative embodiments may include other means of coupling the drone in the carriage. Clamping, flexion plates, or other methods that allow removable attachment are viable alternatives to snap-hooking discussed above.

### BRIEF DESCRIPTION OF DRAWINGS

FIG. 1A shows a side view of the drone holster

FIG. 1B shows a top view of the drone holster

FIG. 2 shows an exploded bottom perspective view of the drone holster

FIG. 3A shows a top perspective view of the drone holster with a drone attached

FIG. 3B shows a front view of the drone holster with a drone attached

FIG. 4 is a schematic drawing of the drone holster in operation

FIG. 5 is a schematic drawing demonstrating the immediately adjacent point on the drone.

### LIST OF DRAWING NUMBERS

10 Drone Holster
11 Hood
21 Carriage
23 Scaffold
25 Harness
27 Ring
29 Hinge
30 Pivot Pin
31 Snap-hook
33 Carriage padding
34 Hood padding
40 Supplemental coupling device
50 Drone Body
52 Gimbaled camera
54 Drone wing
72 Top of Drone Body
74 Drone Propellers
75 Backpack loop
77 Backpack
80 Immediately Adjacent Point

### DETAILED DESCRIPTION OF DRAWINGS

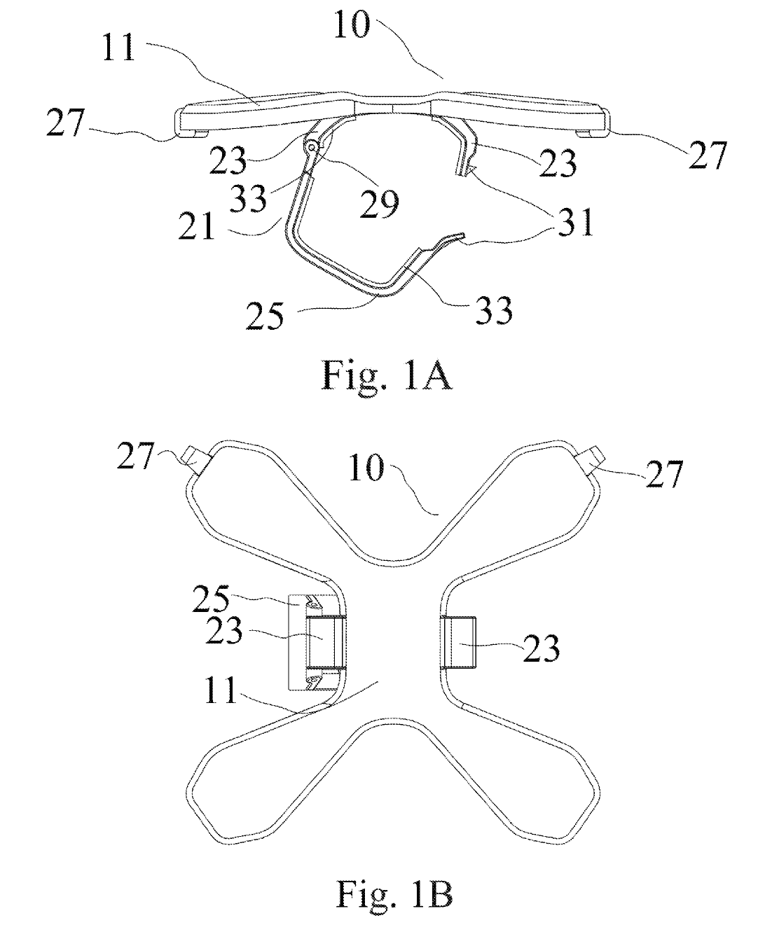

FIG. 1A depicts the drone holster 10 in isolation. The carriage 21 is conjoined with the hood 11. The scaffolding 23 and harness 25 are permanently attached by a hinge 29. The hinge 29 enables the harness 25 to pivot relative to the hood 11, permitting installation and removal of a drone. The carriage 21 is locked by utilizing, a snap-hook 31 on the side opposite the hinge. Padding 33 lines the inner surfaces of the carriage 21 abutting a drone.

FIG. 1B depicts the dimensions of the exemplary hood 11. Four symmetrical arms are configured to cover the wings, rotors, and propellers of a stationary wing quad-.copier drone. Two rings 27 are conjoined with the tip of two of the, hood 11 arms. The rings 27 enable attachment of a carabiner or other supplementary coupling mechanism. The scaffolding 23 can be seen to the sides of the narrow portion of the hood 11. For effective weight distribution the scaffolding 23, harness 25, and hinge 29 are in the middle of the drone holster 10.

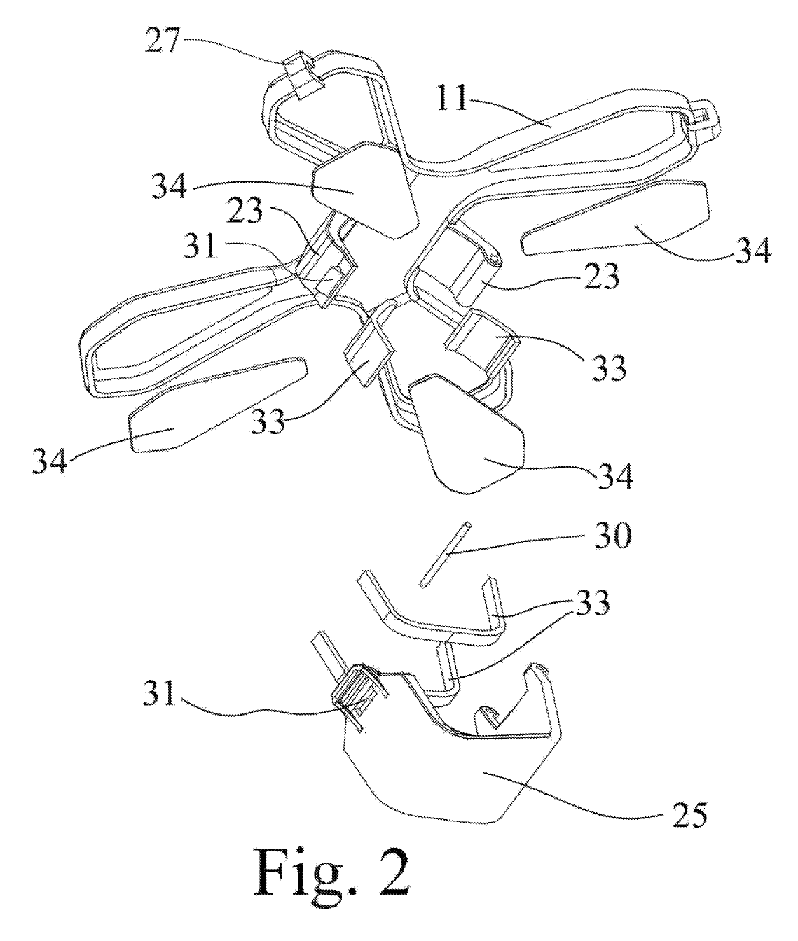

FIG. 2 illustrates the individual components and design of the exemplary drone holster 10. Four hood pads 34 are configured to line the underside of the hood 11 abutting the drone. In the exemplary embodiment polyurethane foam is used for its force absorption and durability. The edge of the hood 11 extends down, surrounding the top of the body and wings of the drone. The male aspect of the snap-hook 31 is conjoined with the carriage scaffolding 23. Four separate carriage pads 33 are fitted to receive and cushion the drone when installed in the drone carriage 21. The pivot pin 30 connects the drone harness 25 with the scaffolding 23. The female aspect of the snap-hook 31 is conjoined to the harness 25 in alignment with the male aspect 31.

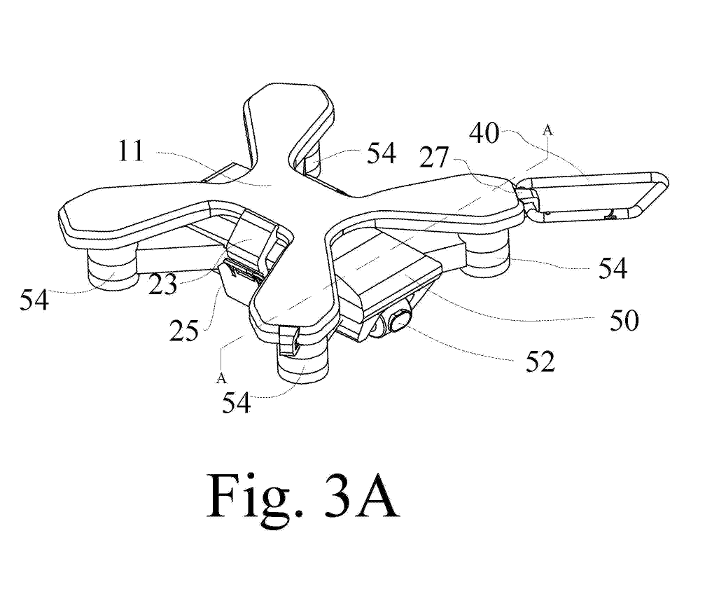

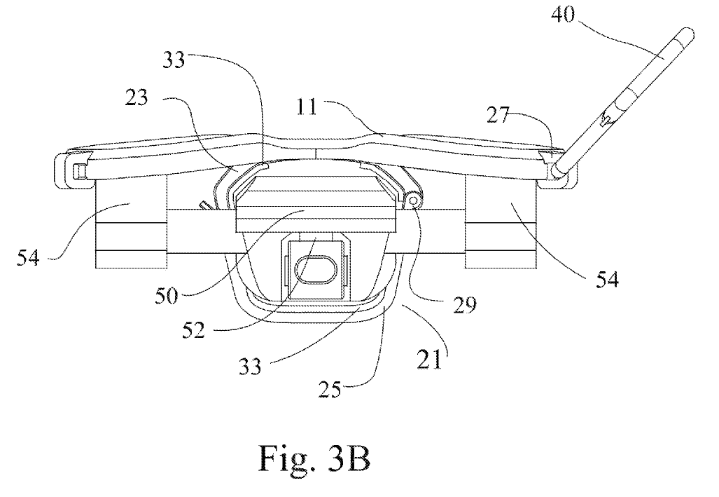

FIGS. 3A-3B depict the drone holster in use. A drone body 50 is coupled by the carriage 21. The harness 25 supports the bottom of the drone and is locked to the scaffolding 25 via the snap-hook 31. The hood 11 covers and protects the top and sides of the drone wings 54. The gimbaled camera 52 remains accessible while coupled, permitting manual operation. A supplementary coupling device 40, here a carabiner, is inserted into a ring 27. The carriage padding 33 abuts the bottom, top, and sides of the drone. The hood extends beyond the dimensions of the drone, effectively protecting the gimbaled camera 52 and drone body 50. As can be seen, the hood covers the top of the wings 54 and propellers of the drone. When the snap-hook 31 is disengaged the harness 25 pivotally rotates by the hinge 29. The harness 25 side comprising the snap-hook 31 swings down and away from the drone body 50. A user can remove the drone by grabbing the drone body 50. The drone body 50 is more durable than propellers and drone wings 54. The top of a drone may also consist of implements subject to miscalibration, such as the propellers and a power button.

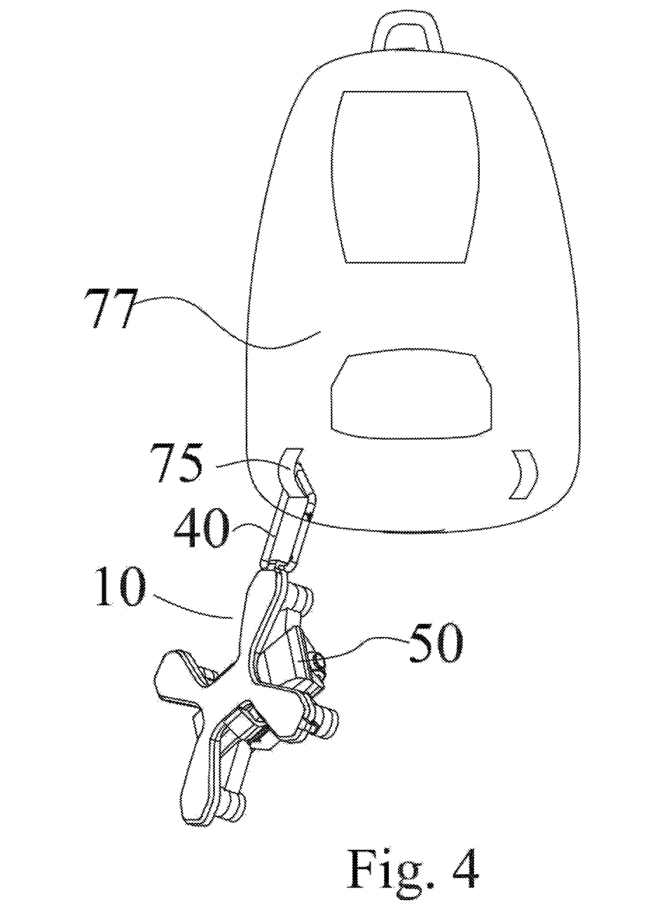

FIG. 4 depicts the supplementary coupling device 40 used to attach the holster 10 to an object, here a backpack 77 loop 75. The snap-hook 31 is opened and the drone 50 removed when ready for use.

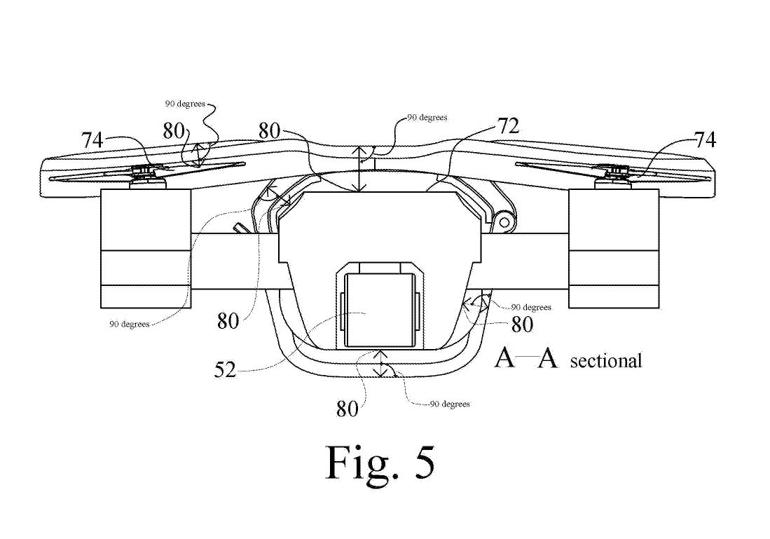

The hood (11) extends no greater than 20 mm above an immediately adjacent point (80) on a drone body top (72). The immediately adjacent point is the point at which a line extending perpendicularly from the hood (11) outer surface intersects with the drone body top. FIG. 5 demonstrates this intersection. Drone body top (72) means the uppermost planar surface (72) of the drone body (50) and the uppermost planar surfaces of the drone propellers (74).

The carriage 21 also contours to the drone body 50. The carriage 21 extends no greater than 15 s mm from the immediately adjacent point (80) on a coupled drone body surface. Extension is measured from the outer surface of the carriage 21. The “drone body surface” does not include recesses or indentations created to house a drone camera or gimbal. The extension limitation does not apply to the hinge 29 or snap-hook 13 aspects of the carriage 21. The hinge 29 and snap-hook 31 may extend obliquely from the drone and thereby create distortions in the extension measurement.

The foregoing discussion discloses and describes merely exemplary methods and embodiments. As will be understood by those familiar with the art, the disclosed subject matter may be embodied in other specific forms without departing from the essence or characteristics thereof. Accordingly, the foregoing disclosure is intended to be illustrative, but not limiting, of the scope of the invention, which is set forth in the following claims.

1. A holster for a drone, comprising:
a. a carriage configured to receive a drone, having at least two sides and a harness base joining the sides;
b. a hood configured to cover a top of the drone, said hood not extending greater than 20 millimeters above a top of a immediately adjacent point of a body of a coupled drone body top;
c. the carriage being attached to the hood in at least one place;
d. said carriage permitting removable attachment of the drone;
e. said carriage sides not extending greater than 15 millimeters from the immediately adjacent point of coupled drone body side surface;
f. said harness base not extending greater than 15 millimeters from the immediately adjacent point of a coupled drone body bottom side surface;
g. said holster being configured to leave a portion of the drone exposed and capable of being touched when coupled.

2. A device for transportation of a drone, comprising:
a. a hood comprised of plastic material;
b. said hood configured to cover a top of a body and wings of the drone;
c. a carriage having a top scaffolding portion and a bottom harness portion;
d. said top scaffolding comprised of a first top scaffolding side and a second top scaffolding side, said first top scaffolding side and second top scaffolding side being conjoined with and extending down from the hood;
e. said bottom harness portion having two sides and a bottom contiguously configured to receive a drone body, the harness being attached to the scaffold by a hinge on one side;
f. the side of said bottom harness opposing the hinge containing one aspect of a snaphook;
g. the top scaffolding containing the corresponding aspect of a snap-hook;
h. said carriage being, configured to a drone body when the top and bottom of the carriage are coupled;
i. the top scaffolding and bottom harness not extending greater than 15 mm from the immediately adjacent point of coupled drone body side surface when the snap-hook aspects are coupled;
j. the hood not extending greater than 20 mm from the immediately subjacent point of a coupled drone body top surface;
k. said drone and carriage being configured to expose a portion of a coupled drone.

3. The device in claim 2 wherein one or more rings capable of attachment of a supplementary coupling device are conjoined to the hood.

4. A method of transporting a drone, comprising:
a. a holster capable of coupling a drone and being engaged by a supplemental coupling device;
b. said supplemental coupling device being capable of being attached to a garment or other object;
c. said supplemental coupling device is attached to a garment or outside of another object;
d. the holster permitting partial exposure of the drone when coupled.

5. A method of protecting a drone, comprising:
a, connecting a drone to a drone holster;
b. said drone holster being comprised of a hood and carriage;
c. said carriage being comprised of a first side and a second side, and a harness base, the sides being connected to and extending from the hood, the harness base being actively coupled with a first side by a hinge, the opposing side of the harness base removably coupling with the second side by snap-hook;
d. a top of the drone being covered and partially surrounded by the hood;
e. the drone being inserted into the carriage and the snap-hook being engaged to couple the inserted drone;
f, the coupled drone remaining partially exposed to outside physical contact;
g. the hood not extending greater than 20 mm from the top of the immediately adjacent part of the drone body top;
h. the harness base not extending greater than 15 mm from the immediately adjacent part of the drone body.

6. (canceled)

7. The method in claim 5, wherein the hood contains at least one ring permitting attachment of a carabiner or other supplementary coupling device.

8. The method in claim 5, wherein a supplementary coupling device is permanently attached to the drone holster,

9. The method in claim 5, wherein the supplementary coupling device includes a retractable reel or other mechanism allowing for extension of the drone while coupled,

10. A device for protecting and coupling a quadcopter drone having a top, sides and four wings, the device comprising:
a. a stationary hood comprised of resilient material;
b. said hood being configured to cover the top of a quadcopter drone body and the four wings;
c. a carriage configured to contour to the sides and bottom of the drone body;
d. said carriage having two sides and a bottom;
e. said carriage being comprised of a top scaffolding and bottom harness base;
f. a hinge operatively coupling the harness base operatively coupling with the scaffold on one side of the carriage;
g. said harness base and scaffolding comprising coupling aspects enabling the harness base to couple with the scaffolding on the carriage side opposing the hinge;
h. said carriage being open on two sides, partially exposing, said quadcopter drone.

11. The device for protecting and coupling a quadcopter drone in claim 10, wherein the hood and carriage are comprised of a glass-filled polymer outer layer and a polyurethane layer lining a portion of the side of the hood and carriage that is disposed toward a coupled drone.

12. The device for protecting and coupling a quadcopter drone in claim 10, wherein the coupling aspects are snap-hook coupling aspects.
